(19) United States
(12) Patent Application Publication
(10) Pub. No.: US 2024/0316701 A1
(43) Pub. Date: Sep. 26, 2024

(54) ADJUSTABLE FIXTURE ASSEMBLY FOR LASER MARKING OBJECTS

(71) Applicant: LMTGPR LLC, Caro, MI (US)

(72) Inventor: Samuel Palmeter, Caro, MI (US)

(73) Assignee: LMTGPR LLC, Caro, MI (US)

(21) Appl. No.: 18/128,147

(22) Filed: Mar. 29, 2023

Related U.S. Application Data
(63) Continuation-in-part of application No. 18/125,060, filed on Mar. 22, 2023.

(51) Int. Cl. B23K 37/04; B23K 26/36; B23K 37/02

(52) U.S. Cl. CPC B23K 37/0435; B23K 26/36; B23K 37/0211

(57) ABSTRACT

An adjustable fixture assembly for marking objects, such as pistols, includes a base and an adjusting device. The base includes a platform having a first end, a second end, a pair of side walls, and a pair of tracks extending between the first end, and a second end. An activator section includes a neck section and a motor section including a motor having a circular base and a clamping surface for engaging the rear side of the pistol, wherein the clamping surface includes a first axis. The activator section includes a cradle member for holding the pistol. A laser marking device marks the pistol, as the pistol is fixedly attached to the cradle. As the cradle rotates about the axis, the laser marking device marks various surfaces of the pistol at various angles thereby allowing variety and flexibility in laser marking.

### FIELD OF THE INVENTION

The present invention relates to laser marking, and more particularly, the present invention relates to an apparatus for laser marking of various substrates, such as weapons.

### DESCRIPTION OF THE BACKGROUND OF THE PRIOR ART

Laser marking methods have recently been developed for marking metals, plastics, ceramics and glasses. As known by those skilled in the art, the known methods of a laser marking of metals typically involves a vaporization process, wherein a laser is used to remove or ablate metal from the surface along the travel path of the laser. The resultant marking comprises engraved or indented portions which provide three-dimensional contrast to the surface of the metal.

There is another alternative process of laser marking of metals surfaces including annealing a selected portion of the metal surface to provide areas of contrasting color, wherein instead of removing metal from the surface, the laser is used to heat the surface of the metal to an annealing temperature which typically results in darkening of the annealed regions. Alluding to the above, plastics are typically laser marked by either changing the color of the plastic or engraving the surface of the plastic along the travel path of the laser. The color of the plastic is typically changed by localized melting and re-solidification of the plastic. In contrast, engraving is achieved by vaporization and removal of the plastic.

Various plastic laser engraving methods can be used to remove a surface layer of the plastic to reveal an underlying layer of contrasting color. In this prior art methods, two coating layers are applied to a glass substrate, and the top layer is removed by the laser to reveal the contrasting underlayer. Another prior art method teaches laser marking ceramics and glasses by using a glaze having a radiation-sensitive additive comprising an inorganic pigment or titanium dioxide is deposited and fired on the surface of a ceramic or glass substrate. A laser beam is then used to irradiate the fired surface layer to thereby change the color of the surface layer in the areas of irradiation.

Another prior art method teaches application of marking material to the surface of the substrate, followed by irradiation of a portion of the marking material to form a permanent marking on the substrate. The non-irradiated portion of the marking material is then removed from the substrate. The marking material may comprise glass frit or precursors thereof, inorganic pigments or precursors thereof, silicates, metal oxides, sulfides, nitrides and carbides, organometallic material or metal powders. The marking method is highly versatile, can be performed quickly, and produces permanent marks of high resolution and contrast without damage to the substrate.

Still another prior art reference teaches a method of laser marking metals, plastics, ceramic materials, glazes, glass ceramics, and glasses of any desired form, which comprises applying to the material to be marked a variable thickness layer of marking material containing energy absorbing enhancers then irradiating said layer with a laser or diode based energy source such that the radiation is directed onto said layer in accordance with the form of the marking to be applied, and using a laser or diode based energy source of a wavelength which is sufficiently absorbed by the marking material so as to create a bonding of the marking material to the surface of the workpiece at the irradiated areas.

Despite the above-noted marking techniques, a need still exists for a method of marking substrates such as metals, ceramics, glasses and plastics which is versatile and can be performed quickly, and which produces permanent marks of high resolution and contrast with minimal or no damage to the substrate.

There is also an opportunity for improved fixture device for fixedly holding various object such as weapons for marking the weapon while the weapon is fixedly attached to the fixture device without any movements during lase marking of the weapon.

The present invention aims to solve this problem by simple and convenient means.

### SUMMARY OF THE INVENTION

An adjustable fixture assembly for marking objects, such as pistols, includes a base and an adjusting device. The base includes a platform having a first end, a second end, a pair of side walls, and a pair of tracks extending between the first end, and a second end. An activator section extends from the first end. The activator section includes a neck section and a motor section including a motor having a circular base and a clamping surface for engaging the rear side of the pistol, wherein the clamping surface includes a first axis and three clamping elements movable to and away from the first axis to fixedly engage the butt side of the pistol.

The activator section includes a cradle member. The cradle includes a tongue section having side edges with a plurality of voids of various geometrical configurations and a pair of side arm sections connected to both side edges. The side edges extend to respective tip portions connected to the circular base wherein the cradle is rotatable about the first axis. A tower device is engaged with at least one of the tracks and is slidable movable along the tracks between the first end and the second end. The tower device includes a carriage having a channel defined in the bottom of the carriage to engage at least one of the tracks. A handle is connected to the carriage to move the tower device to and away from the activator section. A brake device is connected to the front end of the carriage to fixedly connect the carriage to at least one of the tracks when an extension element is attached to the carriage and extend therefrom vertically and then away from vertical orientation of terminating to a block defining an object engagement surface to be inserted into a muzzle end of the barrel of the pistol.

A weapon engaging section or a holding device for securing the pistol. The holding device includes a first part having at least one inclined surface. The first part includes a bottom surface to be connected to the tongue section. Several openings are defined in the inclined surface. A second part includes a rear inclined surface to be engaged with the inclined surface. The second part includes a top end defining a lip section with a female connector to mate with the opening and a central section with an inlet to mate with the opening.

A bracket section extends from the central section. The bracket section terminates to C-shape bracket defining an elongated opening. A pair of male connectors are used to connect the first part with the second part as the rear inclined surface is connected to the inclined surface.

An insert member is used to be inserted into an opening defined in the handle of the pistol. The insert member includes a plurality of openings. The insert member is inserted to or engaged with the C-shape bracket of the bracket section wherein the insert member is moved relative an axis and fixed by a second mail connector inserted through the elongated opening and any of the openings as the insert member is moved along the axis.

A laser marking device marks the pistol, as the pistol is fixedly attached to the cradle. As the cradle rotates about the axis, the laser marking device marks various surfaces of the pistol at various angles thereby allowing variety and flexibility in laser marking.

Advantage of the present invention is to provide an inventive fixture device for fixedly holding various object such as weapons for marking the weapon while the weapon is fixedly attached to the fixture device without any movements during laser marking of the weapon.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective view of an adjustable fixture assembly for marking objects, such as a pistol;

FIG. 2 illustrates a side view of the adjustable fixture assembly for marking the pistol, shown in phantom;

FIG. 3 illustrates a fragmental and exploded view of a holding device for securing the pistol; and

FIG. 4 illustrates another side view of the adjustable fixture assembly for marking the pistol.

### DETAILED DESCRIPTION OF THE INVENTION

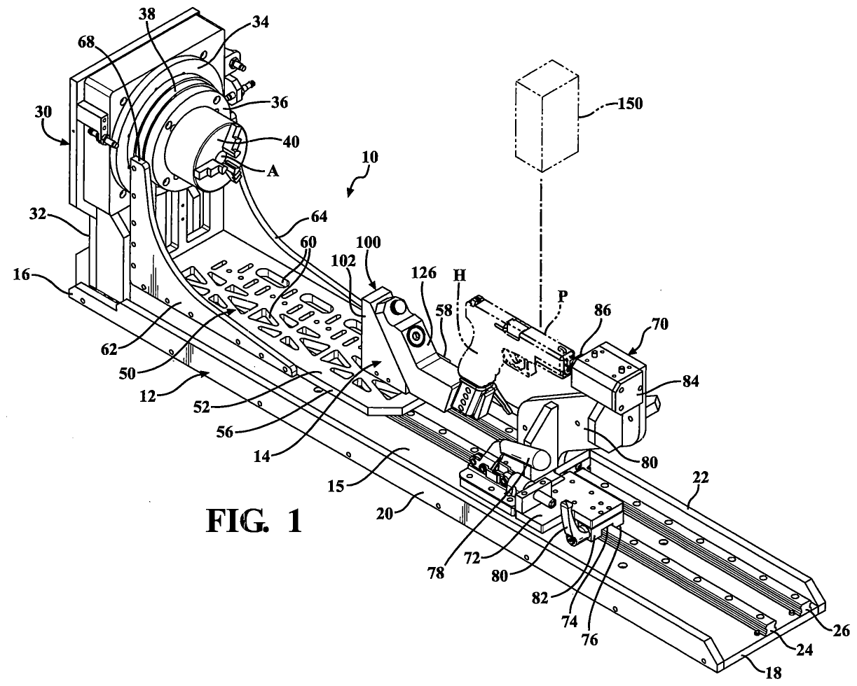

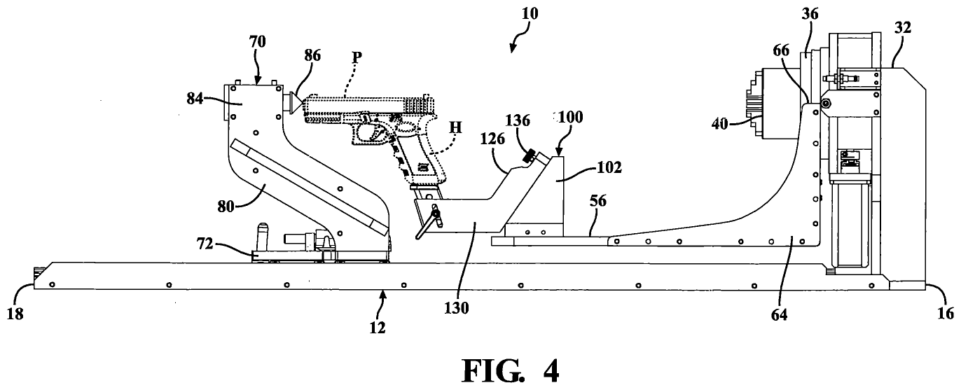

Referring to the FIGS. 1 through 4, an adjustable fixture assembly for marking objects, such as pistols, with laser, is generally shown at 10. Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments.

These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

The adjustable fixture assembly 10 for marking objects, such as pistol(s) P, shown in phantom, and pistols (not shown) includes a base, generally indicated at 12 and an adjusting device, generally indicated at 14. The base 12 includes a platform 15 having a first end 16, a second end 18, a pair of side walls 20, 22, and a pair of tracks 24, 26 extending between the first end 16, and a second end 18. The base 12 is placed on a surface, such as a worktable (not shown) or can be a part of another installation (not shown).

An activator section, generally indicated at 30, extends from the first end 16. The activator section 30 includes a neck section 32 and a motor section 34 including a motor 36 having a circular base 38 and a clamping surface 40. The clamping surface 40 includes a first axis A.

The activator section 30 includes a cradle member, generally indicated at 50. The cradle 50 includes a tongue section 52 having side edges 56, 58 with a plurality of voids of various geometrical configurations (only one is shown at 60) and a pair of side arm sections 62, 64 connected to both side edges 56, 58. The side edges 56, 58 extend to respective tip portions 66, 68 connected to the circular base 38 wherein the cradle 50 is rotatable about the first axis A. All components such as the base 12, the activator section 30, the cradle 50 are formed from polymeric and non-polymeric materials without limiting the scope of the present invention.

Alluding to the above, a tower device, generally indicated at 70, is engaged with at least one of the tracks 24, 26 and is slidable movable along the tracks 24, 26 between the first end 16 and the second end 18. The tower device 70 includes a carriage 72 having a channel 74 defined in the bottom 76 of the carriage 72 to engage at least one of the tracks 24, 26. A handle 78 is connected to the carriage 72 to move the tower device 70 to and away from the activator section 30.

A brake device 80 is connected to the front end 82 of the carriage 72 to fixedly connect the carriage 72 to at least one of the tracks 24, 26 when an extension element 80 is attached to the carriage 72 and extend therefrom vertically and then away from vertical orientation of terminating to a block 84 defining an object engagement surface 86 to be inserted into a muzzle end of the barrel of the pistol R. The tower device 70 is formed from polymeric and non-polymeric materials without limiting the scope of the present invention.

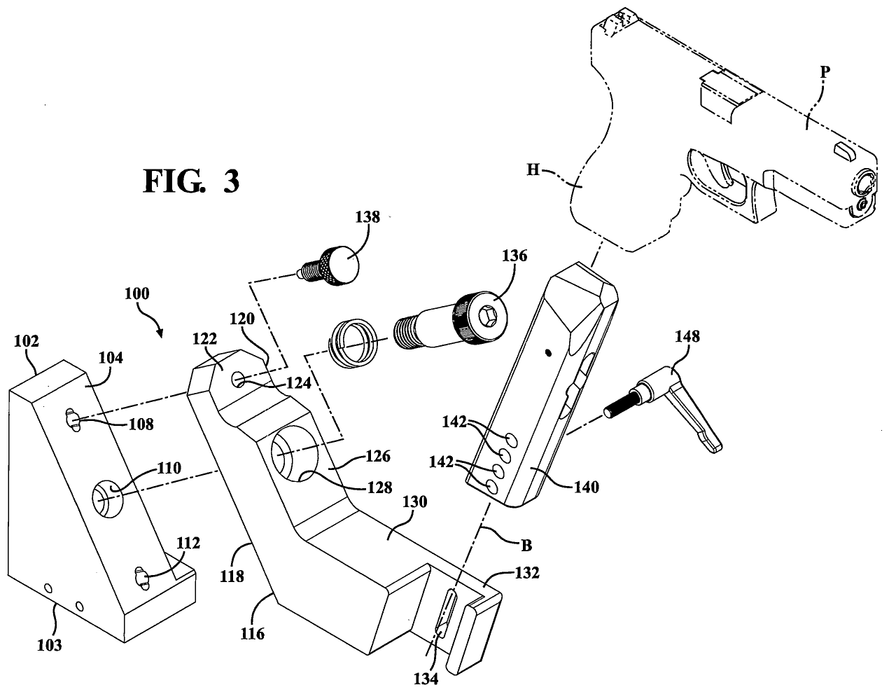

As best shown in FIG. 3, the assembly 10 includes a weapon engaging section or a holding device for securing the pistol P, generally indicated at 100. The holding device 100 includes a first part 102 having at least one inclined surface 104. The first part 102 includes a bottom surface to be connected to the tongue section 52. Several openings 108, 110, and 112 are defined in the inclined surface 104. A second part 116 includes a rear inclined surface 118 to be engaged with the inclined surface 104. The second part 116 includes a top end 120 defining a lip section 122 with a female connector 124 to mate with the opening 108 and a central section 126 with an inlet 128 to mate with the opening 110.

A bracket section 130 extends from the central section 126. The bracket section 130 terminates to C-shape bracket 132 defining an elongated opening 134. A pair of male connectors 136 and 138 are used to connect the first part 102 with the second part 116 as the rear inclined surface 118 is connected to the inclined surface 104. The second part 116 may change orientation based on required/desired position of the pistol P to be laser marked. The second part 116 is rotated about the male connector 136 wherein the lip section 122 with the female connector 124 will mate with the opening 112 defined in the inclined surface 104 wherein the C-shape bracket 132 will be positioned above the first part 102

An insert member 140 is used to be inserted into an opening defined in the handle H of the pistol P. The insert member 140 includes a plurality of openings 142. The insert member 140 is inserted to or engaged with the C-shape bracket 132 of the bracket section 130 wherein the insert member 140 is moved relative an axis B and fixed by a second mail connector 148 inserted through the elongated opening 134 and any of the openings 142 as the insert member 140 is moved along the axis B.

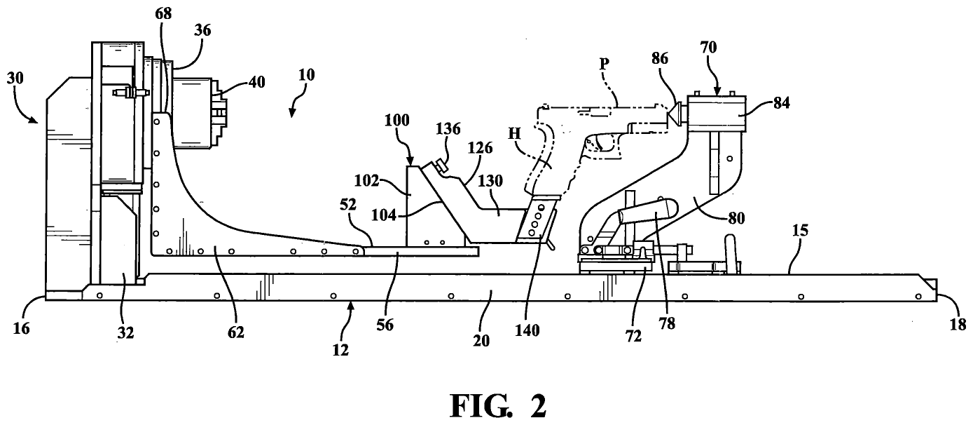

A laser marking device, as shown in phantom at 150, marks the pistol R, as the pistol P is fixedly attached to the cradle 50, as best shown in FIG. 2. The assembly 10, can be activated remotely. As the cradle 50 rotates about the axis, the laser marking device 150 marks various surfaces of the pistol R at various angles thereby allowing variety and flexibility in laser marking.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment disclosed as the best mode contemplated for carrying out this invention, but that the invention will include all embodiments falling within the scope of the appended claims.

1. An adjustable fixture assembly for marking objects, such a pistol, with laser, said adjustable fixture assembly comprising:
a base including a platform having a first end, a second end, a pair of side walls;
an activator section extending from said first end, a circular base and a clamping surface for engaging the rear side of the pistol, wherein said clamping surface including a first axis;
a cradle member of said activator section includes a tongue section; and
a weapon engaging section includes a first part connected to said tongue section and a second part presenting a bracket section for holding the pistol to be marked, said second part is movable between multiple positions as said second section is fixed to said first part and further moved to a position wherein said second part is rotated about said first part as said bracket section is mover above said first part to fixedly engage the pistol and to prevent relative movement of the pistol in connection to said tongue section.

2. The adjustable fixture assembly as set forth in claim 1, wherein said activator section including a neck section and a motor section including a motor having said circular base.

3. The adjustable fixture assembly as set forth in claim 1, wherein said base includes a pair of tracks extending between said first end, said a second end.

4. The adjustable fixture assembly as set forth in claim 1, wherein said clamping surface includes at least one clamping element movable to and away from the first axis A to fixedly engage the butt side of the pistol.

5. The adjustable fixture assembly as set forth in claim 1, wherein said tongue section of said cradle member includes side edges with a plurality of voids of various geometrical configurations and a pair of side arm sections connected to both side edges, said side edges extend to respective tip portions connected to said circular base wherein said cradle is rotatable about the first axis.

6. The adjustable fixture assembly as set forth in claim 1, including a tower device is engaged with at least one of said tracks and is slidable movable along said tracks between said first end and said second end, said tower device includes a carriage having a channel defined in the bottom of the carriage to engage at least one of the tracks.

7. The adjustable fixture assembly as set forth in claim 6, including a handle is connected to said carriage to move said tower device to and away from said activator section.

8. The adjustable fixture assembly as set forth in claim 7, including a brake device connected to said front end of said carriage to fixedly connect said carriage to at least one of said tracks when an extension element is attached to said carriage and extend therefrom vertically and then away from vertical orientation terminating to a block defining an object engagement surface to be inserted into a muzzle end of the barrel of the pistol.

9. The adjustable fixture assembly as set forth in claim 1, wherein said first part presents at least one inclined surface, said first part including a bottom surface to be connected to said tongue section.

10. The adjustable fixture assembly as set forth in claim 9, wherein a plurality of openings are defined in said inclined surface.

11. The adjustable fixture assembly as set forth in claim 10, wherein said second part includes a rear inclined surface to be engaged with said inclined surface, said second part presenting a top end defining a lip section with a female connector to mate with said opening and a central section with an inlet to mate with said opening.

12. The adjustable fixture assembly as set forth in claim 11, including a bracket section extending from said central section.

13. The adjustable fixture assembly as set forth in claim 12, wherein said bracket section terminates to a C-shape bracket defining an elongated opening.

14. The adjustable fixture assembly as set forth in claim 13, including a pair of male connectors used to connect said first part with said second part as said rear inclined surface is connected to said inclined surface.

15. The adjustable fixture assembly as set forth in claim 14, including an insert member inserted into an opening defined in the handle of the pistol, said insert member presenting a plurality of openings, wherein said insert member is inserted to or engaged with said C-shape bracket of said bracket section.

16. The adjustable fixture assembly as set forth in claim 15, wherein said insert member is moved relative an axis and fixed by a second mail connector inserted through said elongated opening and any of said openings as said insert member is moved along the axis.

17. The adjustable fixture assembly as set forth in claim 14, including a laser marking device marks the pistol, as the pistol is fixedly attached to said cradle, as said cradle rotates about the axis, as said laser marking device marks various surfaces of the pistol at various angles thereby allowing variety and flexibility in laser marking process.

18. An adjustable fixture assembly for marking objects, such a pistol, with laser, said adjustable device comprising:
a base including a platform having a first end, a second end, a pair of side walls, and a pair of tracks extending between said first end, said a second end;
an activator section extending from said first end, said activator section including a neck section and a motor section including a motor having a circular base and a clamping surface for engaging the rear side of the pistol, wherein said clamping surface including a first axis and three clamping elements movable to and away from the first axis to fixedly engage the butt side of the pistol;
a cradle member of said activator section includes a tongue section having side edges with a plurality of voids of various geometrical configurations and a pair of side arm sections connected to both side edges, said side edges extend to respective tip portions connected to said circular base wherein said cradle is rotatable about the first axis;
a tower device is engaged with at least one of said tracks and is slidable movable along said tracks between said first end and said second end, said tower device includes a carriage having a channel defined in the bottom of the carriage to engage at least one of the tracks;
a handle is connected to said carriage to move said tower device to and away from said activator section; and
a brake device connected to said front end of said carriage to fixedly connect said carriage to at least one of said tracks when an extension element is attached to said carriage and extend therefrom vertically and then away from vertical orientation terminating to a block defining an object engagement surface to be inserted into a muzzle end of the barrel of the pistol;
a holding device for securing the pistol, said holding device includes a first part having at least one inclined surface, said first part including a bottom surface to be connected to said tongue section;
a plurality of openings are defined in said inclined surface;
a second part including a rear inclined surface to be engaged with said inclined surface; said second part presenting a top end defining a lip section with a female connector to mate with said opening and a central section with an inlet to mate with said opening;
a bracket section extending from said central section, said bracket section terminating to C-shape bracket defining an elongated opening;
a pair of male connectors are used to connect said first part with said second part as said rear inclined surface is connected to said inclined surface; and
an insert member inserted into an opening defined in the handle of the pistol, said insert member presenting a plurality of openings, wherein said insert member is inserted to or engaged with said C-shape bracket of said bracket section wherein said insert member is moved relative an axis and fixed by a second mail connector inserted through said elongated opening and any of said openings as said insert member is moved along the axis.
